(19) United States
(12) Patent Application Publication
(10) Pub. No.: US 2006/0200257 A1
(43) Pub. Date: Sep. 7, 2006

(54) Microprocessor system for a machine controller in safety-certifiable applications

(76) Inventors: Hans-Herbert Kirste, Landesbergen (DE); Michael Lehzen, Minden (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/361,046

(22) Filed: Feb. 24, 2006

(30) Foreign Application Priority Data
Mar. 3, 2005 (DE) 10 2005 009 795.2

(51) Int. Cl. G05B 9/02; G05B 19/18

(52) U.S. Cl. 700/79; 700/2

(57) ABSTRACT

A microprocessor system for a machine controller used in safety-critical applications includes a main processor, a program and/or data store, an input/output unit and a bus. The bus couples the components and at least one safety processor together. The safety processor has a dedicated program/data store. A safe transmission link is provided for loading programs and data into the safety processor. The transmission link includes the general bus and a mailbox (87) which has a state machine whose input is connected to the general bus and whose output is connected to the safety processor. As a result, program data can be written to the safety processor's program store without the risk of being manipulated. This makes it possible for the program data to be loaded into the safety processor safely using the bus which is not safe per se. The bus thus does not need to belong to the safe area. Certification of the microprocessor controller is thus simplified.

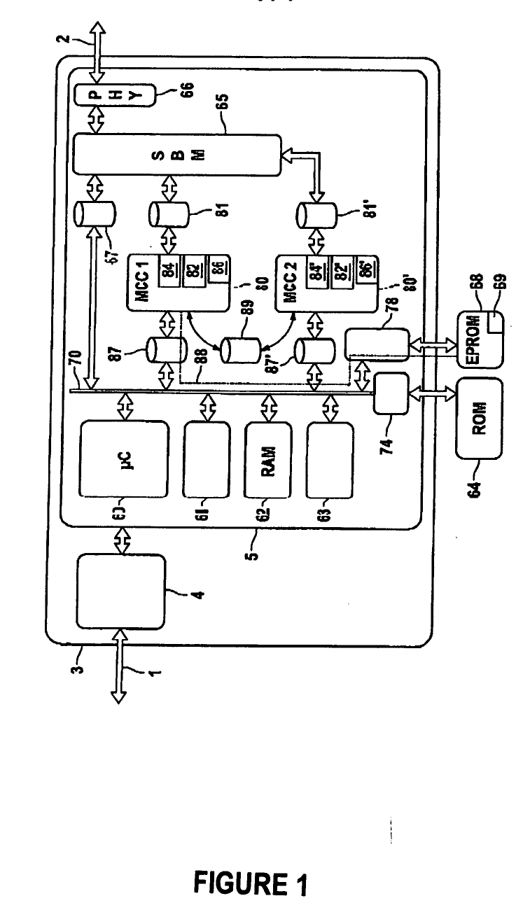

The invention relates to a microprocessor system for a machine controller in safety-certifiable applications, said microprocessor system comprising a main processor, a program and data store, an input/output unit and a bus for coupling the abovementioned components and also at least one safety processor which has a dedicated program/data store and is likewise connected to the bus.

The field of automation technology has been characterized by two main directions of development which are partly parallel and partly contrary to one another. One main direction of development is the use of ever more complex electronic control systems, particularly microprocessor controllers. The other main direction of development concerns the safety of the controller itself and that of the system controlled by the latter. Noticeably more extensive and more exacting safety demands are imposed in this case. The field of electrical, electronic and programmable electronic systems (“E/E/PES”), in particular, is noticeably receiving attention from the aspect of safety. Although microprocessor-based systems afford the advantage of a wide variety of functions and thus, in principle, also good initial preconditions for implementing an effective safety concept, it is not possible, or is possible only to a very limited extent, to resort to proven assessment standards, which have been produced for conventional discrete electrical or electronic equipment, in order to assess said microprocessor-based systems, precisely on account of their greater level of complexity. So that microprocessor controllers can also be used and certified under defined conditions in safety-relevant areas, they must satisfy particular demands which are imposed on failure immunity and fault tolerance. This is regulated in corresponding standards, for example IEC 61508 or EN 954-1. These standards define various levels of safety (SIL or category) and specify conditions for achieving them. These standards are generally independent of technology and do not give any direct instructions as regards structural embodiment options for complying with them.

An attempt is thus made to develop microprocessor controllers in such a manner that they are able to satisfy the safety conditions specified in the standards. To this end, it is known practice, from obvious prior use, to also provide dedicated safety processors in addition to the actual (main) processor. These safety processors form a safety area and are thus a core part of the safety functionality. However, when analyzing safety, it is not possible to stop at just the safety processors, but rather it is also necessary to take into account the peripherals which are needed to operate the latter. These peripherals include, in particular, memories and bus devices. In microprocessor systems which are known from obvious prior use, components are frequently provided, for reasons of cost, for joint use by the main processor and the safety processors, particularly a joint bus for transmitting data and addresses. However, the bus which is jointly used can no longer be associated with the safety area. This results in problems during certification. In order to avoid these problems, a dedicated bus may be provided. However, this is disadvantageous for reasons of complexity. It would thus give rise to considerable additional development and production costs.

The invention is based on the object of providing a microprocessor controller of the type mentioned initially, in the case of which these disadvantages are avoided or at least arise only to a relatively minor extent.

The inventive solution resides in the features of the independent claim. The dependent claims relate to advantageous developments.

In the case of a microprocessor system for a machine controller in safety-certifiable applications, said microprocessor system comprising an unsafe area having a main processor, a program and data store, an input/output unit and a bus for coupling the abovementioned components and also a safe area having at least one safety processor which has a dedicated program/data store and is likewise connected to the bus, the invention provides for a protected transmission channel to be designed to load programs/data into the safety processor's dedicated program/data store and to comprise a data source, which can be connected to the bus and has a checking data area, and a mailbox, which is associated with the safety processor, whose input is connected to the bus and whose output is connected to the safety processor's dedicated memory, a state machine which is designed to transmit data from the data source to the safety processor's memory and is designed to use data from the checking data area for the purpose of verification also being provided.

The invention is based on the idea of providing a transmission channel which is protected against unauthorized corruption on the generally used bus which is not safe, and thus to enable safe communication with the safety processor. The invention thus enables safe communication with the safety processor without the need for additional hardware for this purpose. This protected transmission channel is formed via the bus which is not safe per se and to which, on the one hand, the data source, which contains data which are to be protected and are intended for the safety processor's dedicated memory, in the unsafe area and, on the other hand, the mailbox at the junction to the safe area are connected. These components interact as follows: the data to be transmitted are in the data source which is not safe per se. Said data are passed, usually under the control of the main processor and its peripheral elements, for example DMA controllers, to the mailbox via the bus. The mailbox separates the main processor from the safety processor and forwards the data which have been transmitted via the bus to the safety processor. The data which have been transported to the mailbox in this manner are written to the safety processor's dedicated memory. The main processor does not have access to the data beyond the mailbox. In this respect, the mailbox isolates the safe area from the rest of the areas. The data are protected from unauthorized access from the outside thanks to this isolation by the mailbox; in particular, the main processor cannot reach the safety processor's program or data store beyond the mailbox. Thanks to the invention, a safety analysis can thus concentrate on the safe area having the safety processor and the latter's dedicated memory. It only needs to be verified that the data have reached the dedicated memory in uncorrupted form. According to the invention, this is effected using the state machine and the data from the checking area, for example a checksum. The latter is used to check that the data which have been loaded into the dedicated memory are correct. Since only the safe area on the far side of the mailbox has to be examined for analyzing safety, the complexity of safety certification is reduced. Advantages also result during operation. Memory tests thus only need to be carried out for the safety processor's dedicated memory and not for the main memory, which is usually considerably larger. Since such tests are generally repeated cyclically, restricting them to the safety processor's dedicated memory, which is generally small, entails enormous execution-time advantages for the respective application. Thanks to the invention, it is thus possible to communicate safely with the safety processor with only a small amount of additional complexity.

The area on the far side of the mailbox having the safety processor and the dedicated memory is preferably physically separated from the other components. This may be provided, for example, by isolating the relevant area on the die that is used. This makes it possible to achieve freedom from reaction. In this case, freedom from reaction is understood as meaning that an abnormal state in the unsafe area, for example overheating of the main processor, cannot result in impairment, for example maloperation, of the safety processor.

The invention is not restricted to only one safety processor. In many cases, it is expedient if two (or more) safety processors are provided. Higher categories of safety (Safety Integrity Levels (SIL)) can be achieved with an increasing number of safety processors. A plurality of safety processors enable reciprocal monitoring and thus increase the protection against an undetected and thus safety-critical error. In order to provide the safety processors having their respective associated memories with the requisite program and useful data, a dedicated mailbox is preferably provided for each safety processor. This makes it possible to communicate independently with the safety processors. This makes it possible to achieve complete redundancy. As a result, the risk of critical failure is reduced. However, a joint mailbox may also be provided. In order to ensure that the safety processors are each associated with the correct data record, identification features are preferably provided for the data record and the safety processor. These may be ID numbers. A suitable device, for example the state machine, can be used to check whether the correct data record has been transmitted to the intended safety processor.

An additional mailbox which is connected, on one side, to the first safety processor and is connected, on the other side, to the second safety processor may also be provided. This enables safe communication between the safety processors. This is advantageous, in particular, for reciprocal monitoring of the safety processors, thus increasing the safety of the entire microprocessor system further.

In one preferred embodiment, the inventive transmission channel is capable of handling reverse signals. In this case, the term “capable of handling reverse signals” is to be understood as meaning that data can be read from the safety processor's dedicated memory in the reverse manner. It is thus possible to transmit useful data, which have been generated in the safety processors, to the outside, likewise whilst complying with safe conditions.

In one proven embodiment, the main processor and the safety processor(s) are arranged on a die. This has the advantage of a particularly compact design. This also has the advantage that unauthorized access to components is effectively prevented on account of the compactness and isolation. Further peripheral components are also expediently arranged on the same chip as far as the latter's connection for the external data source. It is particularly preferred if the safe area is isolated from the remaining area, for example by means of a circumferential depression. The latter is crossed only by communication lines for the mailbox. This increases not only the advantages as regards compactness but also those as regards protection against manipulation.

Some terms which have been used shall be explained below:

A state machine is understood as meaning a flow controller which undertakes a control task in a suitable manner on the basis of external control signals and states. It may be in the form of a separate component or may be integrated in the safety processor.

A mailbox is understood as meaning a memory area which can be used by at least two subscribers to access a defined memory area with the aid of control lines (handshake) which prevent the memory area being accessed simultaneously.

The safety processor's dedicated memory is understood as meaning a memory area which is physically isolated from the main processor's memory. It may be integrated in the safety processor.

The invention will be explained below with reference to the drawing which shows one advantageous exemplary embodiment of the invention.

The single FIGURE shows an exemplary embodiment of a field bus coupler having the inventive microprocessor controller.

A machine controller, which is provided, in its entirety, with the reference numeral 3, is connected to a field bus 1 and to a subbus 2. The field bus 1 may be a bus system which is known per se, for example PROFIBUS, as is sold, inter alia, by Siemens A G. It goes without saying that other bus systems which are suitable as a field bus may also be used. The subbus 2 is a bus system which is designed to network components within a small area, for instance in the area of a machine. In the exemplary embodiment shown, a specific communication bus is used as the subbus 2.

Communication buses of this type are generally proprietary buses associated with individual manufacturers.

The machine controller 3 is designed to function as a mediator between the two bus systems, the field bus 1 and the subbus 2. To this end, the machine controller 3 must be able to provide for protocol conversion. To this end, the machine controller has a microprocessor system which is denoted, in its entirety, using the reference numeral 5. The entire microprocessor system 5 is in the form of a system-on-chip (SOC). It combines all of the requisite components of the microprocessor controller 3, with the exception of an external memory 64. The design of the microprocessor system 5 as an SOC will be explained in more detail below.

In a manner known per se, the microprocessor system comprises a main processor (pC) 60, at least one main memory (RAM) 62 which is in the form of a read/write memory and, if appropriate, further peripheral elements which are represented, in their entirety, by the reference numeral 63. The main processor 60 is preferably in the form of an ARM 946 processor. In order to be coupled to the field bus 61, said main processor is connected to an ASIC 4, which functions as a field bus interface. The main processor 60 is also connected to a bus 70 to which the components (already mentioned) 61 to 63 are also connected. In addition, an external memory 64 is connected to this general bus 70 via a memory controller 74. A conversion unit 65 for the subbus 2 is also connected to the general bus 70 and is in the form of a subbus master (SBM). An interface module (PHY) 66 is provided for the purpose of electrically connecting the subbus 2 to the SBM module 65. A dual-ported RAM 67 (or a FIFO: first in/first out module) is also provided as a buffer for the purpose of connecting the SBM module 65 to the general bus 70.

Two safety processors MCC 1 and MCC 2 80, 80′ are also formed in the microprocessor 5 that is in the form of a system-on-chip. Said safety processors each have, inter alia, a program store 84, 84′ and a data store 82, 82 which are preferably in the form of read/write memories RAM. In a manner known per se, the safety processors are safety-certifiable. Their design and the way in which they work are known from the relevant prior art and therefore do not need to be explained in any more detail. Only the details which are relevant to the invention are therefore explained in more detail below. Since the program memories 84, 84′ in the two safety processors 80, 80′ are in the form of read/write memories, the program data are volatile. It is therefore necessary to put the program data (and also useful data, if appropriate) into the program store 84, 84′ (and into the data store 82, 82′, respectively) after the system has been switched on. If the program memories 84, 84′ are nonvolatile, for example are in the form of flash memories or EPROMs, the comparable task of initially loading the program into the program store at the start of operation or in the case of an update may arise. So that the safety processors 80, 80 continue to satisfy the preconditions for safety certification, the operation of loading the data into the program store 84, 84′ (and the useful data store 82, 82′, if appropriate) must likewise be protected. This is where the invention begins.

The invention provides for the data for the safety processors to be transmitted via the general bus 70. In order to prevent the safety processors being operated with corrupted data, the integrity of the data is checked after they have been transmitted. The concept is thus based on the idea of dispensing with complete shielding of the transmission path and of monitoring the transmission integrity instead. The data are transmitted to the safety processors along a transmission channel which is, in principle, unsafe; the data are protected by checking them after they have been transmitted. This check is carried out in the safe area. If the check is positive, operation may be continued, but, if the check is negative, transmission of the data must be repeated. According to the invention, the data which are to be protected are transmitted to the dedicated program/data store 82, 84, such that they are protected in this manner, by being loaded in via the bus 70 and a mailbox 87. A transmission channel which is protected against unnoticed change is thus provided and is shown in the FIGURE using a dash-dotted line in order to illustrate the flow of data to the first safety processor 80. Said transmission channel connects the safety processor 80 to a memory 68 which is used as an external data source for the program data which are to be loaded into the safety processor 80. In the exemplary embodiment shown, the memory 68 is in the form of an EPROM. Other embodiments are also conceivable, particularly also those in which the memory 68 contains a read/write area in which useful data are kept ready for being loaded into the safety processor 80.

The design of protected transmission via the transmission channel 88 and the way in which it works are as follows: the program data which originate from the EPROM 68 are applied to the general bus 70 using a memory controller 78. Said program data are transmitted to a mailbox 87 via the general bus. The input of said mailbox is connected to the general bus 70 and its output is connected to the safety processor 80. A similar situation applies to a second mailbox 87′ for the second safety processor 80 . The mailbox 87, 87′ is designed to achieve protocol conversion using a state machine 86 which can be implemented using software or discrete logic. As a result, the program data which are transported via the general bus 70 are changed to a format which is suited to being stored in the program store 84 in the safety processor 80. This format is used to store the program data. The state machine 86 uses the checking data to verify that the data have reached the program store 84 in unaltered form. To this end, the transmitted program data comprise suitable checksum data which originate from a checking data area 69 of the data source. If verification reveals that the program data have been altered, the transmitted program data are discarded and the state machine 86 causes renewed transmission. A corresponding procedure is carried out if useful data, if appropriate, are being written to the useful data store 82 or are being read from the latter to the outside. To this end, the mailbox 87 having the state machine, the general bus and the memory controller 78 are preferably capable of handling reverse channels. The state machine in the mailbox 87 is designed in such a manner that it is not possible for the main processor 60 or another component on the general bus to directly access the safety processor 80 and, in particular, the latter's program store 84. This means that, as soon as the data have reached the program store 84 correctly for a start, they are safe there from being manipulated by components in the unsafe area. According to the invention, this means that safety-sensitive data can be loaded into the safety processor 80 via the general bus 70 without the need for a safety analysis of the unsafe area; only the safe area needs to be subjected to the safety analysis.

The above description applies by analogy to the second safety processor 80′ with its program store 84′, its useful data store 82′ and its mailbox 87′ and 81′.

In a corresponding manner, the two safety processors 80, 80′ can communicate via a connecting mailbox 89. A further mailbox 81, 81′ is provided in a corresponding manner in order to connect the safety processors 80, 80′ to the SBM module 65. In this case, the mailbox 81 is designed to transmit transmission data from the safety processor 80 to the SBM module 65. The other mailbox 81′ is designed to transmit received data from the SBM module to the second safety processor 80 . These additional mailboxes interact as follows: for the purpose of transmission, the first safety processor 80 uses the mailbox 81 to provide the SBM module 65 with one part of a data item which is to be transmitted safely. The second part of the data item originates from the second safety processor 80′. For the purpose of transmission, the second part is first of all transmitted to the first safety processor 80 via the connecting mailbox 89 and is then applied by said safety processor to the SBM module 65 via the mailbox 81. The data item to be transmitted is thus complete.

1. A microprocessor system for a machine controller in safety-certifiable applications, said microprocessor system comprising:
an unsafe area having a main processor;
a program and data store;
an input/output unit;
a bus for coupling the main processor the data store and the input/output unit:
a safe area having at least one safety processor which has a dedicated program/data store, said at least one safety processor and said dedicated program/data store being connected to the bus, wherein a protected transmission channel is designed to store programs and data in the dedicated program/data store of the at least one safety processor;
a data source which can be connected to the bus and has a checking data area and a mailbox associated with the at least one safety processor, wherein an whose input is connected to the bus and an output is connected to the dedicated program/data store of the at least one safety processor; and
a state machine which is designed to control data transmission from the data source to the dedicated program/data store of the at least one safety processor and is designed to use data from the checking data area for the purpose of verification.

2. The microprocessor system as claimed in claim 1, further comprising a second safety processor.

3. The microprocessor system as claimed in claim 2, wherein the at least one safety processor and the second safety processor are connected in parallel to the mailbox.

4. The microprocessor system as claimed in claim 2, further comprising a dedicated mailbox for the dedicated connection of the second safety processor.

5. The microprocessor system as claimed in claim 2 further comprising an additional mailbox whose input is connected to the at least one safety processor and whose output is connected to the second safety processor.

6. The microprocessor system as claimed in claim 1 wherein the state machine is designed to check that identification features of the checking data area match those of the safety processors.

7. The microprocessor system as claimed in claim 1 wherein the safe transmission channel is capable of handling reverse signals.

8. The microprocessor system as claimed in claim 1 wherein the main processor and the at least one safety processor arranged on a die.

9. The microprocessor system as claimed in claim 8, wherein the data store, the input/output unit, the bus and the mailbox arranged on said die.

10. The microprocessor system as claimed in claim 1 wherein the safe area is physically isolated from the unsafe area.

11. The microprocessor system as claimed in claim 10 wherein said physical isolation is achieved using a depression in the die.

12. The microprocessor system as claimed in claim 3 further comprising an additional mailbox whose input is connected to the at least one safety processor and whose output is connected to the second safety processor.

13. The microprocessor system as claimed in claim 2 wherein the main processor, the at least one safety processor, and the second safety processor are arranged on a die.
